(19) United States
(12) Patent Application Publication
(10) Pub. No.: US 2025/0379634 A1
(43) Pub. Date: Dec. 11, 2025

(54) METHOD, DEVICE AND COMPUTER STORAGE MEDIUM OF COMMUNICATION

(71) Applicant: NEC Corporation, Tokyo (JP)

(72) Inventors: Peng GUAN, Beijing (CN); Gang WANG, Beijing (CN)

(73) Assignee: NEC Corporation, Tokyo (JP)

(21) Appl. No.: 18/872,980

(22) PCT Filed: Jun. 7, 2022
(86) PCT No.: PCT/CN2022/097339

§ 371 Date: Dec. 9, 2024

(51) Int. Cl. H04B 7/06; H04W 72/23

(52) U.S. Cl. CPC H04B 7/06952; H04W 72/23

(57) ABSTRACT

Embodiments of the present disclosure relate to methods, devices and computer readable media of communication. A terminal device determines an applied beam and determines, based on the applied beam, a subset of beams in a first set of beams for measurements, the subset of beams being used for model inference for beam selection from a second set of beams. In this way, the number of beams to be measured and reported may be reduced and overhead for beam measurements and reporting may be reduced accordingly.

### TECHNICAL FIELD

Embodiments of the present disclosure generally relate to the field of telecommunication, and in particular, to methods, devices and computer storage media of communication for beam management (BM) based on artificial intelligence (AI) or machine learning (ML) model inference.

### BACKGROUND

Currently, spatial domain downlink (DL) beam prediction for a set of beams (also called as Set A) based on measurement results of another set of beams (also called as Set B) is one popular candidate for BM. Set A is used for DL beam prediction, and Set B is used for DL beam measurements. Set B may be a subset of Set A, or Set A and Set B may be different. However, other details of BM in this case are still incomplete and need to be further developed.

### SUMMARY

In general, embodiments of the present disclosure provide methods, devices and computer storage media of communication for AI/ML model inference based BM.

In a first aspect, there is provided a method of communication. The method comprises: determining, at a terminal device, an applied beam; and determining, based on the applied beam, a subset of beams in a first set of beams for measurements, the subset of beams being used for model inference for beam selection from a second set of beams.

In a second aspect, there is provided a method of communication. The method comprises: determining, at a terminal device, a set of predicted beams by model inference with downlink reference signal measurements on a set of configured beams as an input of the model inference; and transmitting, to a network device, information indicating whether a predicted beam in the set of predicted beams is in the set of configured beams.

In a third aspect, there is provided a method of communication. The method comprises: transmitting, at a network device and to a terminal device, a configuration indicating at least one of the following: association between applied beams and a plurality subsets of beams in a first set of beams; a set of reference signals for measurements or transmission; or information of model inference for beam selection from a second set of beams.

In a fourth aspect, there is provided a method of communication. The method comprises: receiving, at a network device and from a terminal device, information indicating whether a predicted beam in a set of predicted beams is in a set of configured beams, the set of predicted beams being determined by model inference with downlink reference signal measurements on the set of configured beams as an input of the model inference.

In a fifth aspect, there is provided a device of communication. The device comprises a processor configured to cause the device to perform the method according to the first or second or third or fourth aspect of the present disclosure.

In a sixth aspect, there is provided a computer readable medium having instructions stored thereon. The instructions, when executed on at least one processor, cause the at least one processor to perform the method according to the first or second or third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating AI/ML model inference based BM in which some embodiments of the present disclosure can be implemented;

FIG. 3 illustrates a schematic diagram illustrating AI/ML model inference based BM according to some embodiments of the present disclosure;

FIG. 4 illustrates a schematic diagram illustrating a process of communication for AI/ML model inference based BM according to some embodiments of the present disclosure;

FIG. 5A illustrates a schematic diagram illustrating an example process of communication for DL RS based BM according to some embodiments of the present disclosure;

FIG. 5B illustrates a schematic diagram illustrating another example process of communication for DL RS based BM according to some embodiments of the present disclosure;

FIG. 5C illustrates a schematic diagram illustrating another example process of communication for DL RS based BM according to some embodiments of the present disclosure;

FIG. 5D illustrates a schematic diagram illustrating an example process of communication for UL RS based BM according to embodiments of the present disclosure;

FIG. 5E illustrates a schematic diagram illustrating another example process of communication for DL RS based BM according to embodiments of the present disclosure;

FIG. 5F illustrates a schematic diagram illustrating another example process of communication for DL RS based BM according to embodiments of the present disclosure;

FIG. 5G illustrates a schematic diagram illustrating another example process of communication for DL RS based BM according to embodiments of the present disclosure;

FIG. 6 illustrates a schematic diagram illustrating a process of communication for beam reporting according to some embodiments of the present disclosure;

FIG. 7 illustrates a schematic diagram illustrating a beam report scheme according to some embodiments of the present disclosure;

FIG. 8 illustrates an example method of communication implemented at a terminal device in accordance with some embodiments of the present disclosure;

FIG. 9 illustrates another example method of communication implemented at a terminal device in accordance with some embodiments of the present disclosure;

FIG. 10 illustrates an example method of communication implemented at a network device in accordance with some embodiments of the present disclosure;

FIG. 11 illustrates another example method of communication implemented at a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM.

The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25GHz to 71GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, spatial domain DL beam prediction for Set A of beams based on measurement results of Set B of beams is one popular candidate for BM. Set B of beams needs to be measured and measurement results need to be reported to serve as an input of AI/ML model inference. Overhead resulted from the beam measurements and the beam report is quite high. In addition, if a predicted beam is not in a configured set of beams, how to report the predicted beam becomes an issue.

In view of this, embodiments of the present disclosure provide solutions of communication for AI/ML model inference based BM so as to overcome the above or other potential issues.

In one solution, a terminal device determines an applied beam and determines a subset of beams in a first set of beams for measurements based on the applied beam. The subset of beams is used for model inference for beam selection from a second set of beams. In this way, the number of beams to be measured and reported may be reduced and overhead for beam measurements and reporting may be reduced accordingly.

In another solution, upon determination of a set of predicted beams by model inference with DL reference signal (RS) measurements on a set of configured beams as an input of the model inference, a terminal device transmits, to a network device, information indicating whether a predicted beam in the set of predicted beams is in the set of configured beams. In this way, beam report on a predicted beam out of the set a configured beams may be enhanced.

For convenience, definitions of some terms in the present disclosure may be listed as below.
In the context of the present disclosure, the term “beams for measurements” or “beams for beam measurements” may comprise beams for NW measurements or UE measurements, and may be interchangeably used with “beams for report”, “beams for measurements and report”, or “beams for transmission”.
The term “beams are used for model inference” may at least comprise: measurement results associated with the beams are used for model inference; transmissions associated with the beams are used for model inference; and/or other information associated with the beams is used for model inference, such as beam ID, beam width, beam angle, beam direction, beam dwelling time, or the like.
The term “DL RS” may refer to a synchronization signal and physical broadcast channel block (SSB) or channel state information-reference signal (CSI-RS). It is to be understood that any other suitable DL RSs are also feasible.
The term “UL RS” may refer to a sounding reference signal (SRS). It is to be understood that any other suitable UL RSs are also feasible.
The term “configured beams” may refer to “transmitted beams”, “measured beams” or “RSs in model training phase”.
The term “non-configured beams” may refer to “non-transmitted beams”, “non-measured beams” or “RSs in model inference phase”.
The term “AI/ML model” may be a data driven algorithm that applies AI/ML techniques to generate a set of outputs based on a set of inputs. AI/ML model may involve model training and model inference. The model training and the model inference may be considered as deployed jointly at a network (NW) and user equipment (UE). It does not preclude AI/ML model training/inference is deployed at NW/UE/operations and maintenance (OAM). If those functions are located in one network entity, a virtual counterpart may be considered, for example, if model training is at NW, virtual UEs may be simulated in training.
The term “data collection” may be a process of collecting data by the network nodes, management entity, or UE for the purpose of AI/ML model training, data analytics and inference. Data collection may be a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model.
The term “training data” may be data needed as input for the AI/ML Model Training function.
The term “inference data” may be data needed as input for the AI/ML Model Inference function.
The term “model training” or “AI/ML model training” may be a process to train an AI/ML Model by learning the input/output relationship in a data driven manner and obtain the trained AI/ML Model for inference. Model training or AI/ML model training may refer to a function that performs the ML model training, validation, and testing which may generate model performance metrics as part of the model testing procedure. The Model Training function is also responsible for data preparation (e.g. data pre-processing and cleaning, formatting, and transformation) based on Training Data delivered by a Data Collection function, if required.
The term “model inference” or “AI/ML model inference” may be a process of using a trained AI/ML model to produce a set of outputs based on a set of inputs. Model inference or AI/ML model inference may refer to a function that provides AI/ML model inference output (e.g. predictions or decisions). The Model inference function is also responsible for data preparation (e.g. data pre-processing and cleaning, formatting, and transformation) based on Inference Data delivered by a Data Collection function, if required.
The term “actor” may refer to a function that receives the output from the Model inference function and triggers or performs corresponding actions. The Actor may trigger actions directed to other entities or to itself.
The term “AI/ML model validation” may refer to a subprocess of training, to evaluate the quality of an AI/ML model using a dataset different from one used for model training, that helps selecting model parameters that generalize beyond the dataset used for model training.
The term “AI/ML model testing” may refer to a subprocess of training, to evaluate the performance of a final AI/ML model using a dataset different from one used for model training and validation. Differently from AI/ML model validation, testing does not assume subsequent tuning of the model.
The term “UE-side (AI/ML) model” may refer to an AI/ML Model whose inference is performed entirely at the UE.
The term “NW-side (AI/ML) model” may refer to an AI/ML Model whose inference is performed entirely at the NW.
The term “One-sided (AI/ML) model” may refer to a UE-side (AI/ML) model or a NW-side (AI/ML) model.
The term “two-sided (AI/ML) model” may refer to a paired AI/ML Model(s) over which joint inference is performed, where joint inference comprises AI/ML Inference whose inference is performed jointly across the UE and the NW, i.e, the first part of inference is firstly performed by UE and then the remaining part is performed by gNB, or vice versa.
The term “AI/ML model transfer” may refer to delivery of an AI/ML model over the air interface, either parameters of a model structure known at the receiving end or a new model with parameters. Delivery may contain a full model or a partial model.
The term “model download” may refer to model transfer from NW to UE.
The term “model upload” may refer to model transfer from UE to NW.
The term “federated learning/federated training” may refer to a machine learning technique that trains an AI/ML model across multiple decentralized edge nodes (e.g., UEs, gNBs) each performing local model training using local data samples. The technique requires multiple interactions of the model, but no exchange of local data samples.
The term “offline field data” may refer to the data collected from field and used for offline training of the AI/ML model.
The term “online field data” may refer to the data collected from field and used for online training of the AI/ML model.
The term “model monitoring” may refer to a procedure that monitors the inference performance of the AI/ML model.
The term “supervised learning” may refer to a process of training a model from input and its corresponding labels.
The term “unsupervised learning” may refer to a process of training a model without labelled data.
The term “semi-supervised learning” may refer to a process of training a model with a mix of labelled data and unlabelled data.
The term “reinforcement learning (RL)” may refer to a process of training an AI/ML model from input (a.k.a. state) and a feedback signal (a.k.a. reward) resulting from the model's output (a.k.a. action) in an environment the model is interacting with.
The term “model activation” may refer to enabling an AI/ML model for a specific function.
The term “model deactivation” may refer to disabling an AI/ML model for a specific function.
The term “model switching” may refer to deactivating a currently active AI/ML model and activating a different AI/ML model for a specific function.
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably.
The terms “group”, “subset” and “set” may be used interchangeably.
The terms “relationship”, “mapping” and “correspondence” may be used interchangeably.

Principles and implementations of the present disclosure will be described in detail below with reference to the figures.

### Example of Communication Network

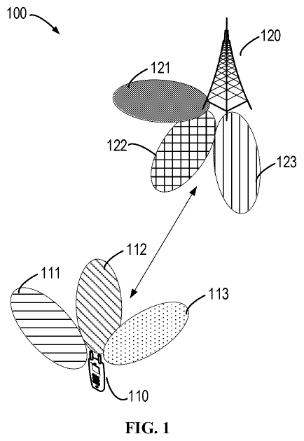

FIG. 1 illustrates an example communication network 100 in which embodiments of the present disclosure can be implemented. As shown in FIG. 1, the communication network 100 includes a terminal device 110 and a network device 120 served by the terminal device 110.

As shown in FIG. 1, the terminal device 110 may have a plurality of beams such as beams 111, 112 and 113, and the network device 120 may have a plurality of beams such as beams 121, 122 and 123. A channel (or called as a sub-channel in this case) may be formed between one of beams 111, 112 and 113 and one of beams 121, 122 and 123. The terminal device 110 may transmit information to the network device 120 or receive information from the network device 120 via one or more of the beams 111, 112 and 113. The network device 120 may transmit information to the terminal device 110 or receive information from the terminal device 110 via one or more of the beams 121, 122 and 123.

It is to be understood that the number of devices and beams in FIG. 1 is given for the purpose of illustration without suggesting any limitations to the present disclosure. The communication network 100 may include any suitable number of network devices and/or terminal devices and/or beams adapted for implementing implementations of the present disclosure.

The communications in the communication network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

Communication in a direction from the terminal device 110 towards the network device 120 is referred to as UL communication, while communication in a reverse direction from the network device 120 towards the terminal device 110 is referred to as DL communication. A wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

In some scenarios, the terminal device 110 may receive, from the network device 120, a configuration indicating beam measurements on a set of DL RSs. Then the terminal device 110 may receive the set of DL RSs and perform DL RS measurements on the set of DL RSs. The terminal device 110 may transmit, to the network device 120, a beam report indicating results of the DL RS measurements. The network device 120 may perform DL beam selection based on the beam report. These scenarios may be called as DL BM.

In some scenarios, the terminal device 110 may receive, from the network device 120, a configuration indicating an UL RS transmission on a set of resources. Then the terminal device 110 may transmit a set of UL RSs to the network device 120. The network device 120 may perform UL RS measurements on the set of UL RSs and perform UL beam selection based on results of the UL RS measurements. These scenarios may be called as UL BM.

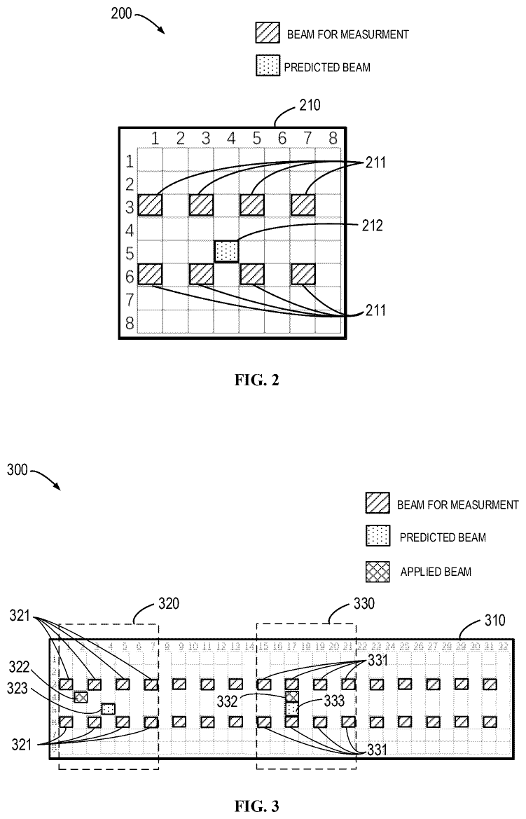

In some scenarios, the UL or DL beam selection may be performed based on AI/ML model inference. FIG. 2 illustrates a schematic diagram 200 illustrating AI/ML model inference based BM in which some embodiments of the present disclosure can be implemented. As shown in FIG. 2, each square box in solid box 210 denotes a beam (or a pair of transmitting (Tx) and receiving (Rx) beams), and beam selection is made among all the beams in the solid box 210. A set of beams 211 in the solid box 210 is used for beam measurements, and results of the beam measurements on the beams 211 are used as an input of model inference. As an output of the model inference, a beam 212 in the solid box 210 may be predicted as the best one of the beams in the solid box 210.

In some scenarios, AI/ML model inference may be carried out at a network device side to perform spatial domain prediction to find the best beam. In this case, a terminal device needs to at least report the subset of beams 211 for beam measurements and corresponding qualities as an input of the AI/ML model.

Payload of legacy report content for beam measurements may be shown by equation (1) below.

$$P = \{ RS ID + RSRP \} * No\_rs , where RS = ceil ( {log}_{2} ( K\_rs ) ) \qquad ( 1 )$$

where P denotes payload of report content for beam measurements, RS ID denotes an identity of a RS, K_rs denotes the number of resources in a corresponding resource set, No_rs denotes the configured number of RSs to be reported and value range of No_rs is 1-4, and RSRP denotes a measured RSRP value. RSRP is 7-bit for absolute value and 4-bit for differential values (for (No_rs−1) RS). To be more precise, payload size may be {RS ID+7-bit absolute RSRP}+{RS ID+4-bit differential RSRP}* (No_rs−1).

In contrast, payload of report content for beam measurements in AI/ML model inference phase may be shown by equation (2) below.

$$P 1 = \{ {ID}_{N W} + {ID}_{U E} + RSRP \} * N 1 \qquad ( 2 )$$

where P1 denotes payload of report content in AI/ML model inference phase. ID_{NW} denotes DL NW Tx beam ID (possibly RS ID that is same as in equation (1)), ID_{UE} denotes DL UE Rx beam ID (that is not exist in equation (1)), worst estimate for payload of ID_{UE} may be ceil(log2(K_rx)), where K_rx denotes the total number of DL UE Rx beams, and best estimate for payload of ID_{UE} may be zero as this information may be still not reported to NW. N1 denotes the subset size of input of AI/ML model inference and N1 may be larger than 4. RSRP denotes a measured RSRP value. RSRP is 7-bit for absolute value and 4-bit for differential values (for (No_rs−1) RS). To be more precise, payload of RSRP may be {RS ID+7-bit absolute RSRP}+{RS ID+4-bit differential RSRP}* (No_rs−1).

It can be seen that beam report overhead in AI/ML model inference phase may be quite high, even higher than that in legacy beam report.

In some scenarios, AI/ML model inference may be carried out at a terminal device side to perform spatial domain prediction to find the best beam. In this case, a terminal device needs to at least measure the subset of beams 211 and obtain corresponding qualities as an input of the AI/ML model. As the number of the subset of beams 211 may be larger than that in legacy beam measurements, beam measurements overhead in AI/ML model inference phase may be still quite high, even higher than that in legacy beam measurements.

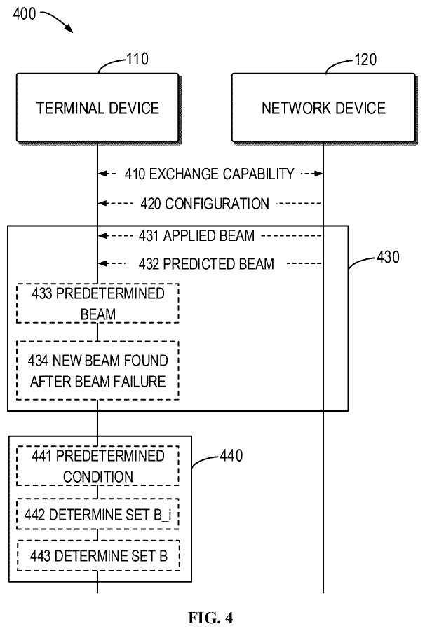

In view of these scenarios, embodiments of the present disclosure provide a solution of AI/ML model inference based BM in order to reduce the beam report and measurements overhead. It is assumed that AI/ML model training is completed and AI/ML model is deployed. The solution will be described in detail with reference to FIG. 3 below.

### Example Implementation of AI/ML Model Inference Based BM

FIG. 3 illustrates a schematic diagram 300 illustrating AI/ML model inference based BM according to some embodiments of the present disclosure. As shown in FIG. 3, each square box in solid box 310 denotes a beam (or a pair of Tx and Rx beams), and beam selection is made among all the beams (for convenience, also called as Set A herein) in the solid box 310. A set of beams (as shown by slash shaded boxes, also called as Set B) in the solid box 310 is used for beam measurements. In some embodiments, Set B may be a subset of Set A. In some embodiments, Set B may be partially overlapped with Set A. In some embodiments, Set B may be not overlapped with Set A. For convenience, the following description is made by taking Set B being a subset of Set A as an example.

With reference to FIG. 3, the set of beams (Set B) in the solid box 310 are divided into subsets (for convenience, also called as Sets B_i herein), for example, beams 321 in dashed box 320 and beams 331 in dashed box 330. For convenience, all beams in each dashed box is called as Set A_i herein. In addition, Set A is divided into subsets, i.e., Set A_i.

With reference to FIG. 3, beams 321 in dashed box 320 are associated with an applied beam 322, and beams 331 in dashed box 330 are associated with an applied beam 332. In this case, only the beams 321 are measured and results of measurements on the beams 321 are used as an input of model inference. As an output of the model inference, a beam 323 in the dashed box 320 may be predicted as the best one of the beams in the solid box 310 or the best one of the beams in the dashed box 320.

As the terminal device moves, an applied beam may change accordingly. For example, the applied beam is changed from the beam 322 to 332. Beams 331 in dashed box 330 are associated with the beam 332. Thus, only the beams 331 are measured and results of measurements on the beams 331 will be used as an input of model inference. As an output of model inference, a beam 333 in the dashed box 330 may be predicted as the best one of the beams in the solid box 310 or the beast one of the beams in the dashed box 330.

In this way, a set of beams for AI/ML model inference input may be updated based on change of a currently applied beam. Accordingly, size of model inference input, report overhead, measurement complexity and RS overhead may be reduced.

FIG. 4 illustrates a schematic diagram illustrating an example process 400 of communication for AI/ML model inference based BM according to embodiments of the present disclosure. For the purpose of discussion, the process 400 will be described with reference to FIG. 1. The process 400 may involve the terminal device 110 and the network device 120 as illustrated in FIG. 1. It is to be understood that the steps and the order of the steps in FIG. 4 are merely for illustration, and not for limitation. For example, the order of the steps may be changed. Some of the steps may be omitted or any other suitable additional steps may be added.

AI/ML model training or deployment is assumed as finished. As shown in FIG. 4, the network device 120 and the terminal device 110 may exchange 410 their capabilities on AI/ML model and RS measurement/report. In some embodiments, capabilities of the network device 120 may comprise at least one of the following: supported AI/ML model, supported collaboration level, or whether to support model switch/updating. It is to be understood that these merely are examples, and any other suitable capabilities are also feasible.

In some embodiments, capabilities of the terminal device 110 may comprise at least one of the following: supported AI/ML model, supported collaboration level, a supported size of Set A, Set A_i, Set B or Set B_i, whether to support model switch/updating, or supported number of resources for measurement/report. It is to be understood that these merely are examples, and any other suitable capabilities are also feasible.

The network device 120 may configure measurement information on the terminal device side and transmit 420 a configuration (e.g., in a RRC reconfiguration message or any other suitable messages) comprising the measurement information to the terminal device 110.

In some embodiments, the network device 120 may configure, to the terminal device 110, association between applied beams and a plurality subsets of beams in a set of beams for measurements (for convenience, also referred to as a first set of beams herein). For example, the network device 120 may configure, to the terminal device 110, association between transmission configuration indicator (TCI) state identities (IDs) and sets of RS IDs. Table 1 shows an example configuration of the association.

TABLE 1

| Beam indication | Associated subset for Model inference input |
|---|---|
| TCI state ID i | Set B_i: {RS ID i_1, RS ID i_2, . . . , RS ID i_Ni} |
| . . . | . . . |
| TCI state ID j | Set B_j: {RS ID j_1, RS ID j_2, . . . , RS ID j_Nj} |

In some embodiments for DL RS based BM, the RS ID in Table 1 may be DL RS ID. In some embodiments for UL RS based BM, the RS ID in Table 1 may be UL RS ID. It is to be understood that Table 1 is merely an example, and any other suitable forms are also feasible.

In some embodiments, signaling may be an entry by entry (or row by row) description of Table 1. In some embodiments, each TCI state may be associated with subset of a different size, e.g., Ni and Nj. In some embodiments, same or different RS IDs may be associated with the same or different TCI state IDs. That is, mappings between TCI state IDs and RS IDs may be many-to-many mappings that may be overlapping, partial overlapping or non-overlapping. In some embodiments, the association may be configured or adjusted based on historical information, specific rule such as spatial consistency, UE suggestions or other UE information.

In some embodiments, the network device 120 may configure, to the terminal device 110, a set of RSs for measurements or transmission. In some embodiments, the network device 120 may configure a set of RSs to be measured for global inference. In some embodiments, the network device 120 may configure a set of RSs to be measured for local inference. In some embodiments, the network device 120 may configure the number of RS to be reported for global inference. In some embodiments, the network device 120 may configure the number of RS to be reported for local inference.

In some embodiments, the network device 120 may configure, to the terminal device 110, information of AI/ML model inference. In some embodiments, the information of AI/ML model inference may comprise a start or end of the model inference. In some embodiments, the information of AI/ML model inference may comprise enabling or disabling of global inference. In some embodiments, the information of AI/ML model inference may comprise enabling or disabling of local inference. In some embodiments, the information of AI/ML model inference may comprise enabling or disabling of determination of a subset of beams based on an applied beam. It is to be understood that any combination of the above information or any other information is also feasible.

It is also to be understood that any combination of the above configurations or any other configurations are also feasible.

When AI/ML model inference is started, the terminal device 110 may perform corresponding operations. As shown in FIG. 4, the terminal device 110 may determine 430 an applied beam, i.e., a currently applied beam. In some embodiments, the terminal device 110 may receive 431 an indication of the applied beam from the network device 120.

In some embodiments where model inference is performed at the network device 120, e.g. in subsequent stages of the model inference, the terminal device 110 may receive 432 an indication of a predicted beam from the network device 120 and determine the predicted beam as the applied beam.

In some embodiments, the terminal device 110 may determine 433 a predetermined beam as the applied beam. In some embodiments, the predetermined beam may be a beam determined during initial access or random access. In some embodiments, the predetermined beam may be the first configured beam or the first N configured beams in a TCI state list. In some embodiments, the predetermined beam may be the latest beam. Of course, any other suitable predetermined ways are also feasible.

In some embodiments, the terminal device 110 may determine 434 a new beam found after a beam failure as the applied beam.

Based on the applied beam, the terminal device 110 may determine 440 a subset of beams (i.e., Set B_i) in a set of beams for measurements (for convenience, also referred to as a first set of beams, i.e., Set B).

The subset of beams is to be used for model inference for beam selection from another set of beams (for convenience, also referred to as a second set of beams, i.e., Set A). For example, the determination of the subset of beams may be done based on the association as shown in Table 1.

In some embodiments, the terminal device 110 may determine 441 whether a predetermined condition is satisfied. In some embodiments, the terminal device 110 may determine whether a predetermined condition is satisfied within a predetermined time period. In some embodiments, the predetermined time period may be X time units, where X may be a predefined value or a configured value or an UE suggested value. For example, X may be 640, 1280, etc. The time units may be milliseconds, slots, frames or any other suitable time units.

If the predetermined condition is unsatisfied, the terminal device 110 may determine 442 the subset of beams, e.g., based on Table 1. The use of the subset of beams for model inference may be called as a local inference. If the predetermined condition is satisfied, the terminal device 110 may determine 443 the first set of beams (i.e., Set B) to be used for the model inference, instead of the subset of beams (i.e., Set B_i). The use of the first of beams for model inference may be called as a global inference.

In some embodiments for the predetermined condition, the terminal device 110 may determine whether an initial access is performed. If an initial access is performed, the terminal device 110 may determine Set B to be used for model inference.

In some embodiments for the predetermined condition, the terminal device 110 may determine whether a random access is performed. If a random access is performed, the terminal device 110 may determine Set B to be used for model inference.

In some embodiments for the predetermined condition, the terminal device 110 may determine whether a beam failure occurs. If a beam failure occurs, the terminal device 110 may determine Set B to be used for model inference.

In some embodiments for the predetermined condition, the terminal device 110 may determine whether a cell change is performed. If a cell change is performed, the terminal device 110 may determine Set B to be used for model inference.

In some embodiments for the predetermined condition, the terminal device 110 may determine whether a bandwidth part (BWP) change is performed. If a BWP change is performed, the terminal device 110 may determine Set B to be used for model inference.

In some embodiments for the predetermined condition, the terminal device 110 may determine whether a band change is performed. If a band change is performed, the terminal device 110 may determine Set B to be used for model inference.

In some embodiments for the predetermined condition, the terminal device 110 may determine whether a physical cell identifier (PCI) change is performed. If a PCI change is performed, the terminal device 110 may determine Set B to be used for model inference.

In some embodiments for the predetermined condition, the terminal device 110 may determine whether an indication indicating that the first set of beams is used for the model inference is received from the network device 120. If the indication is received, the terminal device 110 may determine Set B to be used for model inference. In some embodiments, the indication may explicitly indicate that a global inference or a local inference is to be performed. In some embodiments, the indication may implicit indicate a beam and indicate the beam may be a global optimum, which suggests that a global inference is to be performed. Alternatively, the beam may be associated with a new cell or BWP or band or PCI which also implicitly suggests that a global inference is to be performed.

It is to be understood that these merely are examples and the predetermined condition may comprise any combination of the above and any other suitable conditions.

Comparing with local inference, a larger payload size is expected for global inference. For example, more beams and RSRP needs to be reported, beam ID needs a larger bitwidth, and a higher requirement of RSRP needs to be attained. For example, the number of beams and RSRP to be reported and the bitwidth of beams ID to be reported depends on the number of configured RSs to be measured for global inference and the number of RSs to be reported for global inference. With the setting of the predetermined condition, occasions for global AI/ML model inference may be reduced and thus measurements and report overhead may also be reduced.

Upon determination of the subset of beams, beam measurements or transmission may be performed for model inference. For illustration, some example embodiments will be described below in connection with Embodiments 1 to 7.

### Embodiment 1

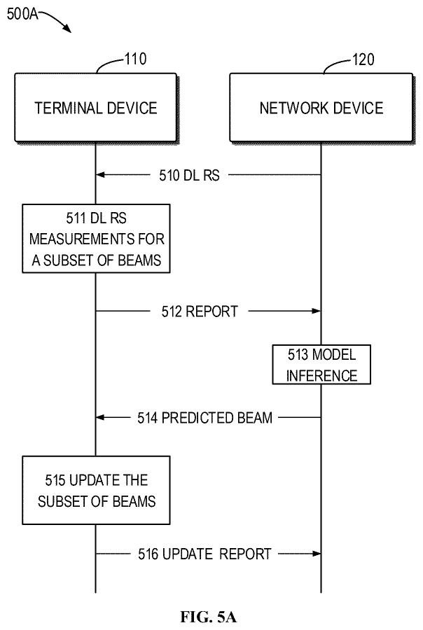

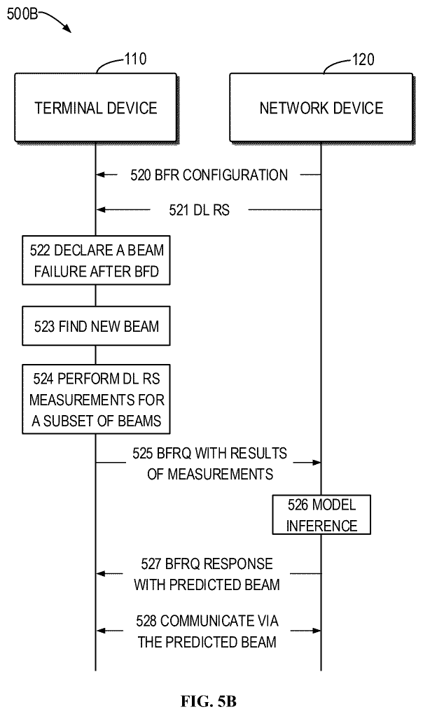

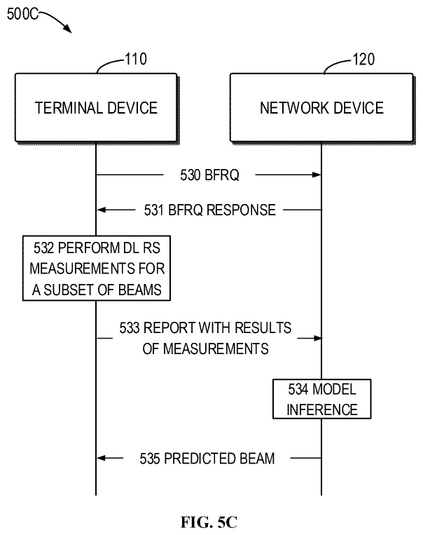

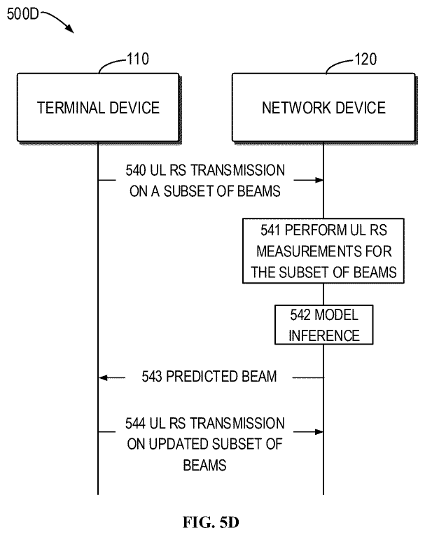

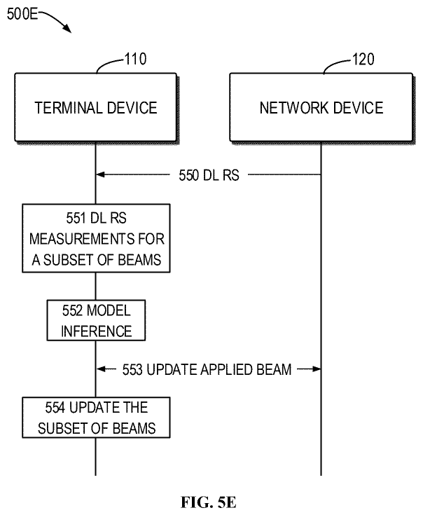

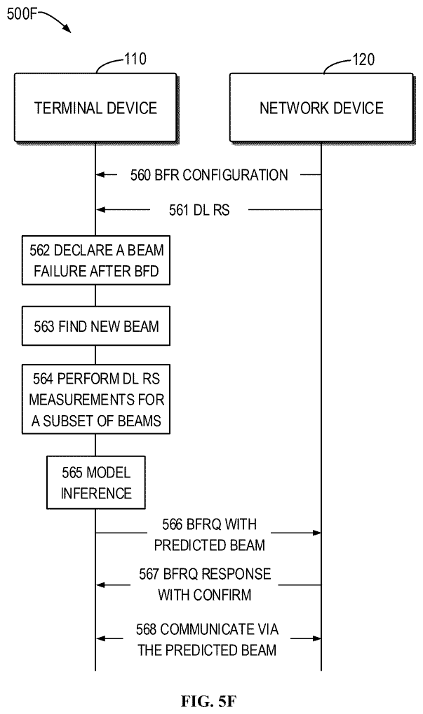

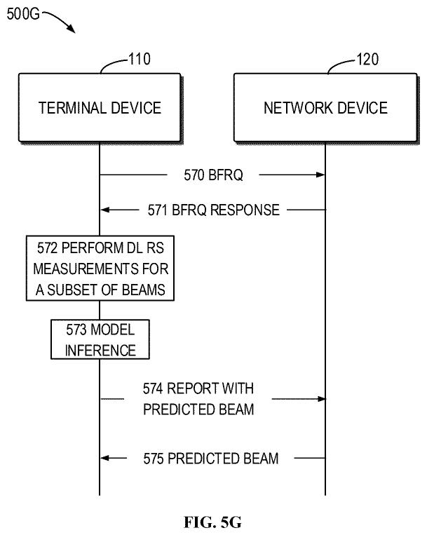

In this embodiment, AI/ML model inference is performed by the network device 120, and the terminal device 110 performs DL beam measurements and report. For illustration, the following description is given in connection with FIG. 5A.

FIG. 5A illustrates a schematic diagram illustrating an example process 500A of communication for DL RS based BM according to embodiments of the present disclosure. For the purpose of discussion, the process 500A will be described with reference to FIG. 1. The process 500A may involve the terminal device 110 and the network device 120 as illustrated in FIG. 1. It is to be understood that the steps and the order of the steps in FIG. 5A are merely for illustration, and not for limitation. For example, the order of the steps may be changed. Some of the steps may be omitted or any other suitable additional steps may be added.

As shown in FIG. 5A, the network device 120 may transmit 510 DL RSs to the terminal device 110. In some embodiments, the network device 120 may transmit the DL RSs periodically. In some embodiments, the network device 120 may transmit the DL RSs in a semi-persistent way. In some embodiments, the network device 120 may transmit the DL RSs in an aperiodic way.

In some embodiments, the network device 120 may transmit the DL RSs on at least Set B_i of beams, assuming that beam i is known by the network device 120. In some embodiments, the network device 120 may transmit the DL RSs on one or more Set B_j (e.g., neighboring beams of the beam i). In some embodiments, the network device 120 may transmit the DL RSs on Set B. In some embodiments, the network device 120 may transmit the DL RSs on Set A. In some embodiments, the network device 120 may transmit the DL RSs on Set A_i. In some embodiments, the network device 120 may transmit the DL RSs on Set A_i and one or more A_j (e.g., neighboring beams).

The terminal device 110 may perform 511 DL RS measurements for the subset of beams as determined in FIG. 4. In some embodiments, the terminal device 110 may measure a parameter of beam quality for the subset of beams. For example, the parameter may be reference signal receive power (RSRP), reference signal receive quality (RSRQ), received signal strength indicator (RSSI) or signal to interference plus noise ratio (SINR). It is to be understood that any other suitable parameters are also feasible.

Then the terminal device 110 may transmit 512 a report indicating results of the DL RS measurements as an input of the model inference.

In some embodiments, the report may comprise a set of reported values for the results of the DL RS measurements. In some embodiments, each reported value in the set of reported values may have accuracy above threshold accuracy. In other words, each reported value may satisfy higher accuracy requirement. For example, the terminal device 110 is required to meet accuracy requirement X when the report is for AI/ML model inference, X is a better accuracy than legacy (+6.5 dB in normal condition and =8.5 dB in extreme condition), for example, X is +3 dB. It is to be noted that this merely is an example, and is not intended for limitation.

In some embodiments, each reported value in the set of reported values may have a range above threshold range. For example, if a reported value is RSRP, the reported value may satisfy larger RSRP range or larger differential RSRP range. For example, the terminal device 110 may report RSRP in a larger range than {−140 dBm,−40 dBm} for AI/ML model inference, or the terminal device 110 may report differential RSRP in a larger range than {0 dB, 30 dB}. It is to be noted that this merely is an example, and is not intended for limitation.

In some embodiments, each reported value in the set of reported values may be above a threshold value. In other words, each reported value may satisfy higher report threshold. For example, the terminal device 110 is only required to report RSRP larger than Y, where Y is larger than legacy report threshold (−140dBm), for example, Y is −110dBm. It is to be noted that this merely is an example, and is not intended for limitation.

In some embodiments, each reported value in the set of reported values may have a quantization step size above a threshold step size. In other words, each reported value may have a finer RSRP quantization. For example, the terminal device 110 may assume a smaller-than-1 dB step size to quantize the RSRP, and a smaller-than-2-dB step to quantize the differential RSRP. It is to be noted that this merely is an example, and is not intended for limitation.

In this way, a dedicated format for measurements report for AI/ML model inference is provided in at least one of accuracy requirement, range and quantization step size, and performance of AI/ML model inference may be improved.

In some embodiments, the terminal device 110 may transmit a set of reported values for the results of the DL RS measurements, the set of reported values being sorted based on IDs of beams in the subset of beams. In some embodiments where the reported value is RSRP and RSRP is sorted by associated beam ID (e.g., RS ID), reference RSRP may be RSRP associated with the first RS ID. Differential RSRP may be calculated with respect to the reference RSRP and may be a positive or negative value.

In some embodiments, the terminal device 110 may transmit, in a first stage of the report, an indication indicating whether each reported value in the set of reported values is above a threshold value. Then the terminal device 110 may transmit, in a second stage of the report, one or more reported values in the set of reported values that are above the threshold value.

In some embodiments, the terminal device 110 may transmit the indication in a bitmap form. For example, 8 RSRP are to be reported, and corresponding bitmap is 11001100. The bitmap suggests only 4 of those will be reported with detailed values in the second stage of the report.

In some embodiments, the terminal device 110 may transmit a reported value for an ID of a Tx beam of the network device 120. In some embodiments, the terminal device 110 may transmit a reported value for a pair of an ID of a Tx beam of the network device 120 and an ID of a Rx beam of the terminal device 110. In some embodiments, the terminal device 110 may transmit a set of reported values for an ID of a Tx beam of the network device 120 and the number of reported values in the set of reported values corresponds to the number of Rx beams of the terminal device 110.

For example, a two-stage report may comprise contents as shown in Tables 2 and 3. Table 2 shows example contents of a stage-1 report.

TABLE 2

| | |
|---|---|
| Stage-1 | Mapping order |
| report | Other information |
| | Bitmap |
| | length = N_i or N1 |

Table 3 shows example contents of a stage-2 report.

TABLE 3

| | |
|---|---|
| Stage-2 | Mapping order |
| report | 1^{st} RS ID corresponds to 1^{st} non-zero position |
| | in bitmap in stage 1 |
| | . . . |
| | N-th RS ID corresponds to N-th non-zero position in bitmap |
| | N can be the number of non-zeros in the bitmap in stage 1 |
| | Model info corresponds to RS ID |
| | 1 per report |
| | 1 per RS ID |
| | Multiple per RS ID |
| | RX beam info corresponds to RS ID |
| | 1 per report |
| | 1 per RS ID |
| | Multiple per RS ID |
| | RSRP/differential RSRP corresponds to RS ID |
| | RSRP corresponds to 1^{st} RS ID and differential RSRP |
| | corresponds to 2^{nd} RS ID |
| | RSRP per RS ID |
| | RSRP per RS ID per model ID |
| | RSRP per RS ID per Rx beam ID |

It is to be noted that Tables 2 and 3 merely are examples and are not intended for limitation.

In some embodiments, the report may further comprise information of a model used for the model inference. In some embodiments, the information of the model may comprise model ID. For example, model ID 1 may be used for 4 receive (Rx) beams, model ID 2 may be used for 8 Rx beams, and so on. As another example, model ID 1 may be used for 32 transmit (Tx) beams, model ID 2 may be used for 64 Tx beams, and so on. As another example, model ID 1 may be used for 32 Tx beams and 4 Rx beams, model ID 2 may be used for 64 Tx beams and 8 Rx beams, and so on. In some embodiments, model ID may indicate how UE is performing AI/ML model inference. In some embodiments, the total number of models (e.g., N models) may be based on NW configuration and/or UE capability reporting.

In some embodiments, the report may further comprise an identity of a Tx beam of the network device 120. In some embodiments, the report may further comprise an identity of an Rx beam of the terminal device 110.

For illustration, example uplink control information (UCI) fields and bitwidths are shown in Table 4 below.

TABLE 4

| field | Bitwidth |
|---|---|
| Model info | Ceil(log2(N_models)) |
| Tx beam info | Ceil(log2(N_i)) |
| Rx beam info | Ceil(log2(K_rx)) |
| RSRP | 7-bit |
| Differential RSRP | 4-bit |

An example mapping order is shown in Table 5.

TABLE 5

1^{st} RS ID
. . .
N-th RS ID
N can be configured number of RS to be reported
N can be Ni
If so, 1^{st} RS ID to N-th RS ID can be ignored in report
Model info corresponds to RS ID
1 per report
1 per RS ID
Multiple per RS ID
RX beam info corresponds to RS ID
1 per report
1 per RS ID
Multiple per RS ID
RSRP/differential RSRP corresponds to RS ID
RSRP corresponds to 1^{st} RS ID and differential RSRP corresponds
to 2^{nd} RS ID
RSRP per RS ID
RSRP per RS ID per model ID
RSRP per RS ID per Rx beam ID

It is to be noted that Tables 4 and 5 merely are examples and are not intended for limitation.

Continue to refer to FIG. 5A, upon reception of the report indicating results of the DL RS measurements, the network device 120 may determine 513 a predicated beam as an output of model inference by taking the results of the DL RS measurements as an input of model inference.

The network device 120 may update 514 the currently applied beam with the predicted beam. Based on the applied beam, the terminal device 110 may update 515 the subset of beams. Based on measurements for the updated subset of beams, the terminal device 110 may transmit 516 updated measurements report for next AI/ML model inference.

In this way, measurements and report for AI/ML model inference input may be dynamically and implicitly updated. Accordingly, overhead comprising size of model inference input, report overhead, measurement complexity and RS overhead may be reduced.

### Embodiment 2

In this embodiment, DL beam measurements and report for model inference are updated during beam failure recovery (BFR). AI/ML model inference is still performed by the network device 120, and the terminal device 110 performs the DL beam measurements and report. For illustration, the following description is given in connection with FIG. 5B.

FIG. 5B illustrates a schematic diagram illustrating another example process 500B of communication for DL RS based BM according to embodiments of the present disclosure. For the purpose of discussion, the process 500B will be described with reference to FIG. 1. The process 500B may involve the terminal device 110 and the network device 120 as illustrated in FIG. 1. It is to be understood that the steps and the order of the steps in FIG. 5B are merely for illustration, and not for limitation. For example, the order of the steps may be changed. Some of the steps may be omitted or any other suitable additional steps may be added.

As shown in FIG. 5B, the network device 120 may transmit 520 a configuration for BFR to the terminal device 110. In some embodiments, the configuration may comprise at least one of the following: association between applied beams and a plurality subsets of beams in the first set of beams; a set of reference signals for measurements or transmission; or information of the model inference. In some embodiments, the configuration may comprise a set of new beam indication (NBI)-RSs.

The network device 120 may transmit 521 DL RSs to the terminal device 110. The terminal device 110. In some embodiments, the network device 120 may transmit the DL RSs periodically. In some embodiments, the network device 120 may transmit the DL RSs in a semi-persistent way. In some embodiments, the network device 120 may transmit the DL RSs in an aperiodic way.

The terminal device 110 may declare 522 a beam failure after beam failure detection (BFD). Then the terminal device 110 may find 523 a new beam (q_new) from the set of NBI-RSs by candidate beam detection (CBD). In some embodiments, the terminal device 110 may determine the set of NBI-RSs based on Set B. After BFD, beam measurements and report may be performed based on Set B.

In some embodiments, the terminal device 110 may determine the set of NBI-RSs based on Set B_i corresponding to a failed beam. After BFD, beam measurements and report may be performed based on Set B_i.

The terminal device 110 may determine 524 a subset (i.e., Set B_i) of beams by taking the new beam as an applied beam, and perform DL RS measurements for the subset of beams.

The terminal device 110 may transmit 525, in a beam failure recovery request (BFRQ) to the network device 120, a report indicating results of the DL RS measurements.

Upon reception of the report indicating the results of the DL RS measurements, the network device 120 may determine 526 a predicated beam as an output of model inference by taking the results of the DL RS measurements as an input of model inference.

The network device 120 may transmit 527 a BFRQ response with indication of the predicted beam. In this way, the currently applied beam may be updated as the predicted beam.

Based on the predicted beam, the terminal device 110 and the network device 120 may communicate 528 with each other via the predicted beam. For example, the terminal device 110 may receive information from the network device 120 via PDCCH or PDSCH. As another example, the terminal device 110 may transmit information to the network device 120 via PRACH, PUCCH or PUSCH. As another example, the terminal device 110 may receive a DL RS from the network device 120 or transmit an UL RS to the network device 120.

In this way, a further refined beam after beam failure may be found based on measurements and report for AI/ML model inference.

### Embodiment 3

In this embodiment, DL beam measurements and report are triggered by a BFRQ response. AI/ML model inference is still performed by the network device 120, and the terminal device 110 performs the DL beam measurements and report. For illustration, the following description is given in connection with FIG. 5C.

FIG. 5C illustrates a schematic diagram illustrating another example process 500C of communication for DL RS based BM according to embodiments of the present disclosure. For the purpose of discussion, the process 500C will be described with reference to FIG. 1. The process 500C may involve the terminal device 110 and the network device 120 as illustrated in FIG. 1. It is to be understood that the steps and the order of the steps in FIG. 5C are merely for illustration, and not for limitation. For example, the order of the steps may be changed. Some of the steps may be omitted or any other suitable additional steps may be added.

As shown in FIG. 5C, upon declaration of a beam failure and found of a new beam, the terminal device 110 may transmit 530 a BFRQ indicating the new beam to the network device 120. The network device 120 may transmit 531 a BFRQ response to the terminal device 110.

In response to receiving the BFRQ response, the terminal device 110 may determine 532 a subset (i.e., Set B_i) of beams by taking the new beam as an applied beam, and perform DL RS measurements for the subset of beams.

The terminal device 110 may transmit 533, to the network device 120, a report indicating results of the DL RS measurements.

Upon reception of the report indicating the results of the DL RS measurements, the network device 120 may determine 534 a predicated beam as an output of model inference by taking the results of the DL RS measurements as an input of model inference.

The network device 120 may transmit 535, to the terminal device 110, an indication of the predicted beam via reconfiguration or activation.

In this way, a new beam after beam failure may also be found based on measurements and report for AI/ML model inference.

### Embodiment 4

In this embodiment, AI/ML model inference is performed by the network device 120. The terminal device 110 performs UL RS transmission and the network device 120 performs UL RS measurements. For illustration, the following description is given in connection with FIG. 5D.

FIG. 5D illustrates a schematic diagram illustrating an example process 500D of communication for UL RS based BM according to embodiments of the present disclosure. For the purpose of discussion, the process 500D will be described with reference to FIG. 1. The process 500D may involve the terminal device 110 and the network device 120 as illustrated in FIG. 1. It is to be understood that the steps and the order of the steps in FIG. 5D are merely for illustration, and not for limitation. For example, the order of the steps may be changed. Some of the steps may be omitted or any other suitable additional steps may be added.

As shown in FIG. 5D, upon determination of the subset of beams as in FIG. 4, the terminal device 110 may transmit 540 a set of UL RSs on the subset of beams.

The network device 120 may perform 541 UL RS measurements for the set of UL RSs. In some embodiments, the network device 120 may measure a parameter of beam quality for the subset of beams. For example, the parameter may be RSRP, RSRQ, RSSI or SINR. It is to be understood that any other suitable parameters are also feasible.

By taking the results of the UL RS measurements as an input of model inference, the network device 120 may determine 542 a predicted beam as an output of model inference.

Then the network device 120 may update 543 the currently applied beam with the predicted beam, and based on the predicted beam, the terminal device 110 may update the subset of beams. Then the terminal device 110 may transmit 544 another set of UL RSs on the updated subset of beams for next AI/ML model inference.

In this way, measurements and report for AI/ML model inference input may also be dynamically and implicitly updated. Accordingly, overhead comprising size of model inference input, measurement complexity and RS overhead may be reduced.

### Embodiment 5

In this embodiment, the terminal device 110 performs DL RS measurements and AI/ML model inference. For illustration, the following description is given in connection with FIG. 5E.

FIG. 5E illustrates a schematic diagram illustrating another example process 500E of communication for DL RS based BM according to embodiments of the present disclosure. For the purpose of discussion, the process 500E will be described with reference to FIG. 1. The process 500E may involve the terminal device 110 and the network device 120 as illustrated in FIG. 1. It is to be understood that the steps and the order of the steps in FIG. 5E are merely for illustration, and not for limitation. For example, the order of the steps may be changed. Some of the steps may be omitted or any other suitable additional steps may be added.

As shown in FIG. 5E, the network device 120 may transmit 550 DL RSs to the terminal device 110. In some embodiments, the network device 120 may transmit the DL RSs periodically. In some embodiments, the network device 120 may transmit the DL RSs in a semi-persistent way. In some embodiments, the network device 120 may transmit the DL RSs in an aperiodic way.

In some embodiments, the network device 120 may transmit the DL RSs on at least Set B_i of beams, assuming that beam i is known by the network device 120. In some embodiments, the network device 120 may transmit the DL RSs on one or more Set B_j (e.g., neighboring beams of the beam i). In some embodiments, the network device 120 may transmit the DL RSs on Set B. In some embodiments, the network device 120 may transmit the DL RSs on Set A. In some embodiments, the network device 120 may transmit the DL RSs on Set A i. In some embodiments, the network device 120 may transmit the DL RSs on Set A i and one or more A_j (e.g., neighboring beams).

The terminal device 110 may perform 551 DL RS measurements for the subset of beams as determined in FIG. 4. In some embodiments, the terminal device 110 may measure RSRP for the subset of beams. It is to be understood that any other suitable parameters are also feasible.

Then the terminal device 110 may determine 552 a predicated beam as an output of model inference by taking the results of the DL RS measurements as an input of model inference.

The terminal device 110 may update 553 the currently applied beam with the predicted beam by transmitting a report indicating the update to the network device 120 and receiving a confirmation of the update from the network device 120. Based on the updated beam, the terminal device 110 may update 554 the subset of beams. The terminal device 110 may perform DL RS measurements for the updated subset of beams for next AI/ML model inference.

In this way, measurements and report for AI/ML model inference input may also be dynamically and implicitly updated. Accordingly, overhead comprising size of model inference input, report overhead, measurement complexity and RS overhead may be reduced.

### Embodiment 6

In this embodiment, DL beam measurements for model inference are updated during BFR, and the terminal device 110 performs the DL beam measurements and AI/ML model inference. For illustration, the following description is given in connection with FIG. 5F.

FIG. 5F illustrates a schematic diagram illustrating another example process 500F of communication for DL RS based BM according to embodiments of the present disclosure. For the purpose of discussion, the process 500F will be described with reference to FIG. 1. The process 500F may involve the terminal device 110 and the network device 120 as illustrated in FIG. 1. It is to be understood that the steps and the order of the steps in FIG. 5F are merely for illustration, and not for limitation. For example, the order of the steps may be changed. Some of the steps may be omitted or any other suitable additional steps may be added.

As shown in FIG. 5F, the network device 120 may transmit 560 a configuration for BFR to the terminal device 110. In some embodiments, the configuration may comprise at least one of the following: association between applied beams and a plurality subsets of beams in the first set of beams; a set of reference signals for measurements or transmission; or information of the model inference. In some embodiments, the configuration may comprise a set of NBI-RSs.

The network device 120 may transmit 561 DL RSs to the terminal device 110. In some embodiments, the network device 120 may transmit the DL RSs periodically. In some embodiments, the network device 120 may transmit the DL RSs in a semi-persistent way. In some embodiments, the network device 120 may transmit the DL RSs in an aperiodic way.

The terminal device 110 may declare 562 a beam failure after BFD. Then the terminal device 110 may find 563 a new beam (q_new) from the set of NBI-RSs by CBD. In some embodiments, the terminal device 110 may determine the set of NBI-RSs based on Set B. After BFD, beam measurements and report may be performed based on Set B.

In some embodiments, the terminal device 110 may determine the set of NBI-RSs based on Set B_i corresponding to a failed beam. After BFD, beam measurements and report may be performed based on Set B_i.

The terminal device 110 may determine 564 a subset (i.e., Set B_i) of beams by taking the new beam as an applied beam, and perform DL RS measurements for the subset of beams.

The terminal device 110 may determine 565 a predicated beam as an output of model inference by taking the results of the DL RS measurements as an input of model inference.

Then the terminal device 110 may transmit 566, in a BFRQ to the network device 120, a report indicating an indication of the predicted beam.

The network device 120 may transmit 567 a BFRQ response with confirm for the predicted beam. In this way, the currently applied beam may be updated as the predicted beam.

Based on the predicted beam, the terminal device 110 and the network device 120 may communicate 568 with each other via the predicted beam. For example, the terminal device 110 may receive information from the network device 120 via PDCCH or PDSCH. As another example, the terminal device 110 may transmit information to the network device 120 via PRACH, PUCCH or PUSCH. As another example, the terminal device 110 may receive a DL RS from the network device 120 or transmit an UL RS to the network device 120.

In this way, a further refined beam after beam failure may be found based on measurements and report for AI/ML model inference.

### Embodiment 7

In this embodiment, DL beam measurements are triggered by a BFRQ response, and the terminal device 110 performs the DL beam measurements and AI/ML model inference. For illustration, the following description is given in connection with FIG. 5G.

FIG. 5G illustrates a schematic diagram illustrating another example process 500G of communication for DL RS based BM according to embodiments of the present disclosure. For the purpose of discussion, the process 500G will be described with reference to FIG. 1. The process 500G may involve the terminal device 110 and the network device 120 as illustrated in FIG. 1. It is to be understood that the steps and the order of the steps in FIG. 5G are merely for illustration, and not for limitation. For example, the order of the steps may be changed. Some of the steps may be omitted or any other suitable additional steps may be added.

As shown in FIG. 5G, upon declaration of a beam failure and found of a new beam, the terminal device 110 may transmit 570 a BFRQ indicating the new beam to the network device 120. The network device 120 may transmit 571 a BFRQ response to the terminal device 110.

In response to receiving the BFRQ response, the terminal device 110 may determine 572 a subset (i.e., Set B_i) of beams by taking the new beam as an applied beam, and perform DL RS measurements for the subset of beams.

The terminal device 110 may determine 573 a predicated beam as an output of model inference by taking the results of the DL RS measurements as an input of model inference.

Then the terminal device 110 may transmit 574, to the network device 120, a report indicating an indication of the predicted beam. The network device 120 may transmit 575, to the terminal device 110, an indication of the predicted beam via reconfiguration or activation.

In this way, a further refined beam after beam failure may also be found based on measurements and report for AI/ML model inference.

### Example Implementation of Beam Report

In some scenarios, a predicted beam may be not in a configured set of beams. However, a beam report using RS ID cannot carry beam information outside the configured set of beams. In view of this, embodiments of the present disclosure provide a solution of communication for beam report so as to overcome the above and other potential issues. For illustration, the solution will be described in connection with FIG. 6.

FIG. 6 illustrates a schematic diagram illustrating an example process 600 of communication for beam reporting according to embodiments of the present disclosure. For the purpose of discussion, the process 600 will be described with reference to FIG. 1. The process 600 may involve the terminal device 110 and the network device 120 as illustrated in FIG. 1. It is to be understood that the steps and the order of the steps in FIG. 6 are merely for illustration, and not for limitation. For example, the order of the steps may be changed. Some of the steps may be omitted or any other suitable additional steps may be added.

As shown in FIG. 6, the network device 120 may transmit 610, to the terminal device 110, a configuration indicating association between configured beams and groups of non-configured beams. For example, the network device 120 may configure, to the terminal device 110, association between configured RS IDs and groups of non-configured RS IDs. Table 6 shows an example configuration of the association.

TABLE 6

| Configured | |
|---|---|
| RS ID | Not configured beams |
| RS ID i | group C_i: {RS ID i_1, RS ID i_2, . . . , RS ID i_Mi} |
| . . . | . . . |
| RS ID j | group C_j: {RS ID j_1, RS ID j_2, . . . , RS ID j_Mj} |

It is to be understood that Table 6 is merely an example, and any other suitable ways are also feasible.

The terminal device 110 may determine 620 a set of predicted beams by model inference with DL RS measurements on a set of configured beams (i.e., Set B) as an input of the model inference. In some embodiments, the set of predicted beams may comprise a predicted beam. In some embodiments, the set of predicted beams may comprise multiple predicted beams. The number of predicted beams may depend on capability of the model.

In some embodiments, the set of predicted beams may be determined as in any of Embodiments 5-7. It is to be understood that the set of predicted beams may also be determined in any other suitable ways, and the present disclosure does not limit this aspect.

With reference to FIG. 6, the terminal device 110 may transmit 630, to the network device 120, information indicating whether a predicted beam in the set of predicted beams is in the set of configured beams.

In some embodiments, the information may comprise an ID of a beam (e.g., RS ID) in the set of configured beams that is close (e.g., closest) to the predicted beam. In some embodiments, the information may comprise an indication indicating that the beam is not the predicted beam. In some embodiments, the information may comprise an indication indicating that whether the beam is not in any groups of non-configured beams. In some embodiments, the information may also comprise RSRP information of the reported beam.

In some embodiments, the information may comprise offset information between the predicted beam and the reported beam. For example, the offset information may be amplitude offset, phase offset, horizontal or vertical angle offset or any other suitable information.

It is to be understood that any combination of the above information and any other suitable information may also be feasible.

In some embodiments where the set of predicted beams comprises multiple beams, the information may comprise an indication indicating whether each of the multiple beams is in the set of configured beams. For example, a bitmap may be used to carry such indication. 1-bit information is required for one reported RS ID.

In some embodiments where the set of predicted beams comprises multiple beams, the information may comprise an indication indicating whether one of the multiple beams that has a best measurement result is in the set of configured beams. For example, 1-bit information may be required to correspond to a RS ID with the highest RSRP.

In some embodiments where the information indicates that a predicted beam in the set of predicted beams is not in the set of configured beams, the network device 120 may determine a group of non-configured beams corresponding to a reported RS ID in the information, e.g., based on Table 6. Then the network device 120 may transmit 640, to the terminal device 110, an indication indicating beam measurements for the determined group of non-configured beams. In other words, a DL beam sweep procedure is triggered. For illustration, an example will be described in connection with FIG. 7 below.

FIG. 7 illustrates a schematic diagram 700 illustrating a beam report scheme according to some embodiments of the present disclosure. As shown in FIG. 7, each square box in solid box 710 denotes a beam (or a pair of Tx and Rx beams), and beam selection is made among all the beams in the solid box 710. A set of beams 711 (as shown by shaded boxes) in the solid box 710 is configured for beam measurements, and results of the beam measurements on the beams 711 are used as an input of model inference. As an output of the model inference, a beam 712 in the solid box 710 may be predicted as the best one of the beams in the solid box 710. It can be seen that the beam 712 is not in the configured set of beams 711. In this case, a RS ID corresponding to a beam 711 that is closest to the beam 712 may be reported to the network. The network may trigger beam measurements for a group of non-configured beams (i.e., beams in solid box 720) associated with the reported RS ID.

Return to FIG. 6, in response to receiving the indication of beam measurements, the terminal device 110 may determine 650 a selected beam by performing the beam measurements. Then the terminal device 110 may transmit 660, to the network device 120, a report indicating the selected beam.

Alternatively, the network device 120 may trigger UL RS transmission for a UL beam sweep procedure. In this case, the terminal device 110 may perform UL RS transmission and the network device 120 may perform beam measurements and sweep procedure to determine a selected beam.

In this way, a predicted beam may be reported to NW.

### Example Implementation of Methods

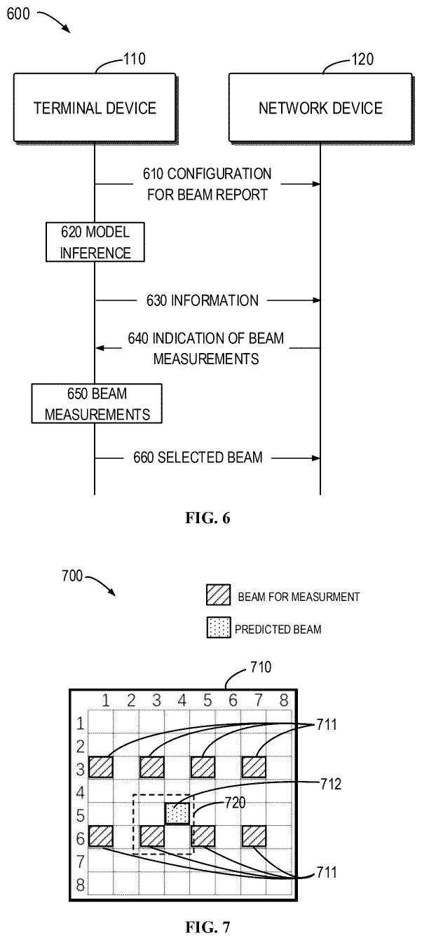

Corresponding to the above process, embodiments of the present disclosure provide methods of communication implemented at a terminal device and a network device. These methods will be described below with reference to FIGS. 8 to 11.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard. It is also to be understood that the method 800 may be carried out when AI/ML model inference is started.

At block 810, the terminal device 110 determines an applied beam. In some embodiments, the terminal device 110 may receive, from the network device 120, an indication of the applied beam. In some embodiments, the terminal device 110 may receive, from the network device 120, an indication of a predicted beam as an output of the model inference. In some embodiments, the terminal device 110 may determine a predetermined beam as the applied beam. In some embodiments, the terminal device 110 may determine, as the applied beam, a new beam found after a beam failure.

At block 820, the terminal device 110 determines, based on the applied beam, a subset of beams in a first set of beams for measurements, the subset of beams being used for model inference for beam selection from a second set of beams.

In some embodiments, the terminal device 110 may receive, from the network device 120, a configuration indicating at least one of the following: association between applied beams and a plurality subsets of beams in the first set of beams; a set of reference signals for measurements or transmission; or information of the model inference.

In some embodiments, the terminal device 110 may determine whether a predetermined condition is satisfied. If the predetermined condition is unsatisfied, the terminal device 110 may determine the subset of beams. If the predetermined condition is satisfied, the terminal device 110 may determine the first set of beams to be used for the model inference.

In some embodiments, the predetermined condition may comprise at least one of the following: an initial access is performed; a random access is performed; a beam failure occurs; a cell change is performed; or an indication indicating that the first set of beams is used for the model inference is received from the network device 120.

In some embodiments, the terminal device 110 may perform DL RS measurements for the subset of beams, and transmit, to the network device 120, a report indicating results of the DL RS measurements as an input of the model inference.

In some embodiments, the terminal device 110 may transmit the report in a BFRQ. In these embodiments, the terminal device 110 may determine, as the applied beam, a new beam found after a beam failure, and receive, in a BFRQ response, an indication of a predicted beam as an output of the model inference.

In some embodiments, the report may comprise a set of reported values for the results of the DL RS measurements. In these embodiments, a reported value in the set of reported values may satisfy at least one of the following: accuracy of the reported value being above threshold accuracy; range of the reported value being above threshold range; the reported value being above a threshold value; or a quantization step size for the reported value being above a threshold step size.

In some embodiments, the terminal device 110 may transmit a set of reported values for the results of the downlink reference signal measurements, the set of reported values being sorted based on identities of beams in the subset of beams. In some embodiments, the terminal device 110 may transmit, in a first stage of the report, an indication indicating whether each reported value in the set of reported values is above a threshold value, and transmit, in a second stage of the report, one or more reported values in the set of reported values that are above the threshold value.

In some embodiments, the terminal device 110 may transmit a reported value for an ID of a Tx beam of the network device. In some embodiments, the terminal device 110 may transmit a reported value for a pair of an ID of a Tx beam of the network device 120 and an ID of a Rx beam of the terminal device 110. In some embodiments, the terminal device 110 may transmit a set of reported values for an ID of a Tx beam of the network device 120, the number of reported values in the set of reported values being the number of Rx beams of the terminal device 110.

In some embodiments, the report may further comprise at least one of the following: information of a model used for the model inference; an ID of a Tx beam of the network device 120; or an ID of a Rx beam of the terminal device 110.

In some embodiments, the terminal device 110 may transmit, to the network device 120, a set of UL RSs on the subset of beams, UL RS measurements for the set of UL RSs being used as an input of the model inference.

In some embodiments, the terminal device 110 may perform DL RS measurements for the subset of beams; determine a predicted beam from a second set of beams by the model inference with the DL RS measurements as the input of the model inference; and transmitting, to the network device 120, a report comprising the predicted beam.

In some embodiments, the terminal device 110 may transmit the report in a BFRQ. In these embodiments, the terminal device 110 may determine, as the applied beam, a new beam found after a beam failure.

With the method 800, the number of beams to be measured and reported may be reduced and overhead for beam measurements and reporting may be reduced accordingly.

FIG. 9 illustrates another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 determines a set of predicted beams by model inference with DL RS measurements on a set of configured beams as an input of the model inference.

At block 920, the terminal device 110 transmits, to the network device 120, information indicating whether a predicted beam in the set of predicted beams is in the set of configured beams.

In some embodiments, the terminal device 110 may receive, from the network device 120, a configuration indicating association between configured beams and groups of non-configured beams.

In some embodiments, the information may comprise at least one of the following: an identity of a beam in the set of configured beams that is close to the predicted beam; an indication indicating that the beam is not the predicted beam; or an indication indicating that whether the beam is not in a group of non-configured beams.

In some embodiments, the set of predicted beams comprises multiple beams, and the information comprises at least one of the following: an indication indicating whether each of the multiple beams is in the set of configured beams; or an indication indicating whether one of the multiple beams that has a best measurement result is in the set of configured beams.

In some embodiments, the terminal device 110 may receive, from the network device 120, an indication indicating beam measurements for a group of non-configured beams determined based on the information; determine a selected beam by performing the beam measurements; and transmit, to the network device 120, a report indicating the selected beam.

With the method 900, beam report on a predicted beam out of the set a configured beams may be enhanced.

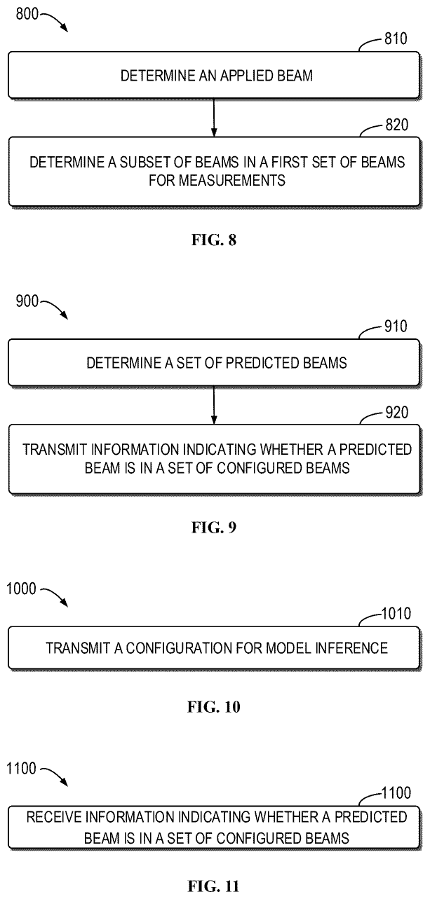

FIG. 10 illustrates an example method 1000 of communication implemented at a network device in accordance with some embodiments of the present disclosure. For example, the method 1000 may be performed at the network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the network device 120 transmits, to the terminal device 110, a configuration indicating at least one of the following: association between applied beams and a plurality subsets of beams in a first set of beams; a set of reference signals for measurements or transmission; or information of model inference for beam selection from a second set of beams.

In some embodiments, the network device 120 may transmit, to the terminal device 110, an indication of an applied beam. In some embodiments, the network device 120 may transmit, to the terminal device 110, an indication indicating that the first set of beams is used for the model inference.

In some embodiments, the network device 120 may receive, from the terminal device 110, a report indicating results of DL RS measurements on a subset of beams in the first set of beams; determine a predicted beam from the second set of beams by the model inference with reported results of the downlink reference signal measurements as an input of the model inference; and transmit, to the terminal device 110, an indication of the predicted beam.

In some embodiments, the network device 120 may receive the report in a BFRQ. In these embodiments, the network device 120 may transmit the indication of the predicted beam in a BFRQ response.

In some embodiments, the report comprises a set of reported values for the results of the downlink reference signal measurements. In these embodiments, a reported value in the set of reported values may satisfy at least one of the following: accuracy of the reported value being above threshold accuracy; range of the reported value being above threshold range; the reported value being above a threshold value; or a quantization step size for the reported value being above a threshold step size.

In some embodiments, the network device 120 may receive a set of reported values for the results of the DL RS measurements, the set of reported values being sorted based on identities of beams in the subset of beams. In some embodiments, the network device 120 may receive, in a first stage of the report, an indication indicating whether each reported value in the set of reported values is above a threshold value, and receive, in a second stage of the report, one or more reported values in the set of reported values that are above the threshold value.

In some embodiments, the network device 120 may receive a reported value for an identity of a transmitting beam of the network device 120. In some embodiments, the network device 120 may receive a reported value for a pair of an identity of a transmitting beam of the network device 120 and an identity of a receiving beam of the terminal device 110. In some embodiments, the network device 120 may receive a set of reported values for an identity of a transmitting beam of the network device 120, the number of reported values in the set of reported values being the number of receiving beams of the terminal device 110.

In some embodiments, the report may further comprise at least one of the following: information of a model used for the model inference; an identity of a transmitting beam of the network device 120; or an identity of a receiving beam of the terminal device 110.

In some embodiments, the network device 120 may receive, from the terminal device 110, a set of UL RSs on a subset of beams in the first set of beams; perform UL RS measurements on the set of UL RSs; determine a predicted beam from the second set of beams by the model inference with the uplink reference signal measurements as an input of the model inference; and transmit, to the terminal device 110, an indication of the predicted beam.

In some embodiments, the network device 120 may receive, from the terminal device 110, a report comprising a predicted beam in the second set of beams.

In some embodiments, the network device 120 may receive the report in a BFRQ.

With the method 1000, reduction of the number of beams to be measured and reported may be facilitated and overhead for beam measurements and reporting may be reduced accordingly.

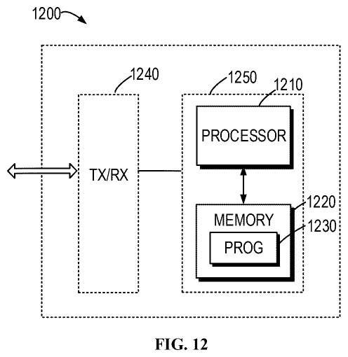

FIG. 11 illustrates another example method 1100 of communication implemented at a network device in accordance with some embodiments of the present disclosure. For example, the method 1100 may be performed at the network device 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the network device 120 receives, from the terminal device 110, information indicating whether a predicted beam in a set of predicted beams is in a set of configured beams, the set of predicted beams being determined by model inference with DL RS measurements on the set of configured beams as an input of the model inference.

In some embodiments, the network device 120 may transmit, to the terminal device 110, a configuration indicating association between configured beams and groups of non-configured beams.

In some embodiments, the information may comprise at least one of the following: an identity of a beam in the set of configured beams that is close to the predicted beam; an indication indicating that the beam is not the predicted beam; or an indication indicating that whether the beam is not in a group of non-configured beams.

In some embodiments, the set of predicted beams may comprise multiple beams. In these embodiments, the information may comprise at least one of the following: an indication indicating whether each of the multiple beams is in the set of configured beams; or an indication indicating whether one of the multiple beams that has a best measurement result is in the set of configured beams.

In some embodiments, the network device 120 may transmit, to the terminal device 110, an indication indicating beam measurements for a group of non-configured beams determined based on the information; and receive, from the terminal device 110, a report indicating a selected beam determined based on the beam measurements.

With the method 1100, beam report on a predicted beam out of the set a configured beams may be enhanced.

### Example Implementation of Device and Apparatus

FIG. 12 is a simplified block diagram of a device 1200 that is suitable for implementing embodiments of the present disclosure. The device 1200 can be considered as a further example implementation of the terminal device 110 or the network device 120 as shown in FIG. 1. Accordingly, the device 1200 can be implemented at or as at least a part of the terminal device 110 or the network device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises a circuitry configured to: determine an applied beam; and determine, based on the applied beam, a subset of beams in a first set of beams for measurements, the subset of beams being used for model inference for beam selection from a second set of beams.

In some embodiments, a terminal device comprises a circuitry configured to: determine a set of predicted beams by model inference with downlink reference signal measurements on a set of configured beams as an input of the model inference; and transmit, to a network device, information indicating whether a predicted beam in the set of predicted beams is in the set of configured beams.

In some embodiments, a network device comprises a circuitry configured to: transmit, to a terminal device, a configuration indicating at least one of the following: association between applied beams and a plurality subsets of beams in a first set of beams; a set of reference signals for measurements or transmission; or information of model inference for beam selection from a second set of beams.

In some embodiments, a network device comprises a circuitry configured to: receive, from a terminal device, information indicating whether a predicted beam in a set of predicted beams is in a set of configured beams, the set of predicted beams being determined by model inference with downlink reference signal measurements on the set of configured beams as an input of the model inference.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: determining, at a terminal device, an applied beam; and determining, based on the applied beam, a subset of beams in a first set of beams for measurements, the subset of beams being used for model inference for beam selection from a second set of beams.

In some embodiments, the method as described above comprises determining the applied beam by: receiving, from a network device, an indication of the applied beam; receiving, from the network device, an indication of a predicted beam as an output of the model inference; determining a predetermined beam as the applied beam; or determining, as the applied beam, a new beam found after a beam failure.

In some embodiments, the method as described above further comprises: receiving, from a network device, a configuration indicating at least one of the following: association between applied beams and a plurality subsets of beams in the first set of beams; a set of reference signals for measurements or transmission; or information of the model inference.

In some embodiments, the method as described above comprises determining the subset of beams by: determining whether a predetermined condition is satisfied; and in accordance with a determination that the predetermined condition is unsatisfied, determining the subset of beams.

In some embodiments, the method as described above further comprises: in accordance with a determination that the predetermined condition is satisfied, determining the first set of beams to be used for the model inference.

In some embodiments, the predetermined condition comprises at least one of the following: an initial access is performed; a random access is performed; a beam failure occurs; a cell change is performed; or an indication indicating that the first set of beams is used for the model inference is received from a network device.

In some embodiments, the method as described above further comprises: performing downlink reference signal measurements for the subset of beams; and transmitting, to a network device, a report indicating results of the downlink reference signal measurements as an input of the model inference.

In some embodiments, the method as described above comprises transmitting the report by transmitting the report in a beam failure recovery request, and determining the applied beam by determining, as the applied beam, a new beam found after a beam failure; or receiving, in a response to the beam failure recovery request, an indication of a predicted beam as an output of the model inference.

In some embodiments, the report comprises a set of reported values for the results of the downlink reference signal measurements, and a reported value in the set of reported values satisfies at least one of the following: accuracy of the reported value being above threshold accuracy; range of the reported value being above threshold range; the reported value being above a threshold value; or a quantization step size for the reported value being above a threshold step size.

In some embodiments, the method as described above comprises transmitting the report by: transmitting a set of reported values for the results of the downlink reference signal measurements, the set of reported values being sorted based on identities of beams in the subset of beams; or transmitting, in a first stage of the report, an indication indicating whether each reported value in the set of reported values is above a threshold value, and transmitting, in a second stage of the report, one or more reported values in the set of reported values that are above the threshold value.

In some embodiments, the method as described above comprises transmitting the report by: transmitting a reported value for an identity of a transmitting beam of the network device; transmitting a reported value for a pair of an identity of a transmitting beam of the network device and an identity of a receiving beam of the terminal device; or transmitting a set of reported values for an identity of a transmitting beam of the network device, the number of reported values in the set of reported values being the number of receiving beams of the terminal device.

In some embodiments, the report further comprises at least one of the following: information of a model used for the model inference; an identity of a transmitting beam of the network device; or an identity of a receiving beam of the terminal device.

In some embodiments, the method as described above further comprises: transmitting, to a network device, a set of uplink reference signals on the subset of beams, uplink reference signal measurements for the set of uplink reference signals being used as an input of the model inference.

In some embodiments, the method as described above further comprises: performing downlink reference signal measurements for the subset of beams; determining a predicted beam from a second set of beams by the model inference with the downlink reference signal measurements as the input of the model inference; and transmitting, to a network device, a report comprising the predicted beam.

In some embodiments, the method as described above comprises transmitting the report by transmitting the report in a beam failure recovery request, and determining the applied beam by determining, as the applied beam, a new beam found after a beam failure.

In another solution, a method of communication comprises: determining, at a terminal device, a set of predicted beams by model inference with downlink reference signal measurements on a set of configured beams as an input of the model inference; and transmitting, to a network device, information indicating whether a predicted beam in the set of predicted beams is in the set of configured beams.

In some embodiments, the method as described above further comprises: receiving, from the network device, a configuration indicating association between configured beams and groups of non-configured beams.

In some embodiments, the information comprises at least one of the following: an identity of a beam in the set of configured beams that is close to the predicted beam; an indication indicating that the beam is not the predicted beam; or an indication indicating that whether the beam is not in a group of non-configured beams.

In some embodiments, the set of predicted beams comprises multiple beams, and the information comprises at least one of the following: an indication indicating whether each of the multiple beams is in the set of configured beams; or an indication indicating whether one of the multiple beams that has a best measurement result is in the set of configured beams.

In some embodiments, the method as described above further comprises: receiving, from the network device, an indication indicating beam measurements for a group of non-configured beams determined based on the information; determining a selected beam by performing the beam measurements; and transmitting, to the network device, a report indicating the selected beam.

In another solution, a method of communication comprises: transmitting, at a network device and to a terminal device, a configuration indicating at least one of the following: association between applied beams and a plurality subsets of beams in a first set of beams; a set of reference signals for measurements or transmission; or information of model inference for beam selection from a second set of beams.

In some embodiments, the method as described above further comprises: transmitting, to the terminal device, an indication of an applied beam; or transmitting, to the terminal device, an indication indicating that the first set of beams is used for the model inference.

In some embodiments, the method as described above further comprises: receiving, from the terminal device, a report indicating results of downlink reference signal measurements on a subset of beams in the first set of beams; determining a predicted beam from the second set of beams by the model inference with reported results of the downlink reference signal measurements as an input of the model inference; and transmitting, to the terminal device, an indication of the predicted beam.

In some embodiments, the method as described above comprises receiving the report by receiving the report in a beam failure recovery request, and transmitting the indication of the predicted beam by transmitting the indication of the predicted beam in a response to the beam failure recovery request.

In some embodiments, the report comprises a set of reported values for the results of the downlink reference signal measurements, and a reported value in the set of reported values satisfies at least one of the following: accuracy of the reported value being above threshold accuracy; range of the reported value being above threshold range; the reported value being above a threshold value; or a quantization step size for the reported value being above a threshold step size.

In some embodiments, the method as described above comprises receiving the report by: receiving a set of reported values for the results of the downlink reference signal measurements, the set of reported values being sorted based on identities of beams in the subset of beams; or receiving, in a first stage of the report, an indication indicating whether each reported value in the set of reported values is above a threshold value, and receiving, in a second stage of the report, one or more reported values in the set of reported values that are above the threshold value.

In some embodiments, the method as described above comprises receiving the report by: receiving a reported value for an identity of a transmitting beam of the network device; receiving a reported value for a pair of an identity of a transmitting beam of the network device and an identity of a receiving beam of the terminal device; or receiving a set of reported values for an identity of a transmitting beam of the network device, the number of reported values in the set of reported values being the number of receiving beams of the terminal device.

In some embodiments, the report further comprises at least one of the following: information of a model used for the model inference; an identity of a transmitting beam of the network device; or an identity of a receiving beam of the terminal device.

In some embodiments, the method as described above further comprises: receiving, from the terminal device, a set of uplink reference signals on a subset of beams in the first set of beams; performing uplink reference signal measurements on the set of uplink reference signals; determining a predicted beam from the second set of beams by the model inference with the uplink reference signal measurements as an input of the model inference; and transmitting, to the terminal device, an indication of the predicted beam.

In some embodiments, the method as described above further comprises: receiving, from the terminal device, a report comprising a predicted beam in the second set of beams.

In some embodiments, the method as described above comprises receiving the report by receiving the report in a beam failure recovery request.

In another solution, a method of communication comprises: receiving, at a network device and from a terminal device, information indicating whether a predicted beam in a set of predicted beams is in a set of configured beams, the set of predicted beams being determined by model inference with downlink reference signal measurements on the set of configured beams as an input of the model inference.

In some embodiments, the method as described above further comprises: transmitting, to the terminal device, a configuration indicating association between configured beams and groups of non-configured beams.

In some embodiments, the information comprises at least one of the following: an identity of a beam in the set of configured beams that is close to the predicted beam; an indication indicating that the beam is not the predicted beam; or an indication indicating that whether the beam is not in a group of non-configured beams.

In some embodiments, the set of predicted beams comprises multiple beams, and the information comprises at least one of the following: an indication indicating whether each of the multiple beams is in the set of configured beams; or an indication indicating whether one of the multiple beams that has a best measurement result is in the set of configured beams.

In some embodiments, the method as described above further comprises: transmitting, to the terminal device, an indication indicating beam measurements for a group of non-configured beams determined based on the information; and receiving, from the terminal device, a report indicating a selected beam determined based on the beam measurements.

In another solution, a device of communication comprises a processor configured to cause the device to perform any of the methods as described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of communication, comprising:
determining, at a terminal device, a set of predicted beams by model inference with downlink reference signal measurements on a set of configured beams as an input of the model inference; and
transmitting, to a network device, information indicating whether a predicted beam in the set of predicted beams is in the set of configured beams.

22. The method of claim 21, further comprising:
receiving, from the network device, a configuration indicating association between configured beams and groups of non-configured beams.

23. The method of claim 21, wherein the information comprises at least one of the following:
an identity of a beam in the set of configured beams that is close to the predicted beam;
an indication indicating that the beam is not the predicted beam; or
an indication indicating that whether the beam is not in a group of non-configured beams.

24. The method of claim 21, wherein the set of predicted beams comprises multiple beams, and wherein the information comprises at least one of the following:
an indication indicating whether each of the multiple beams is in the set of configured beams; or
an indication indicating whether one of the multiple beams that has a best measurement result is in the set of configured beams.

25. A method of communication, performed by a network device, comprising:
receiving, from a terminal device, information indicating whether a predicted beam in a set of predicted beams is in a set of configured beams,
wherein the set of predicted beams is determined by model inference with DL RS measurements on the set of configured beams as an input of the model inference

26. The method of claim 25, further comprising:
transmitting, to the terminal device, a configuration indicating association between configured beams and groups of non-configured beams.

27. The method of claim 25, wherein the information comprises at least one of the following:
an identity of a beam in the set of configured beams that is close to the predicted beam;
an indication indicating that the beam is not the predicted beam; or
an indication indicating that whether the beam is not in a group of non-configured beams.

28. The method of claim 25, wherein the set of predicted beams comprises multiple beams, and wherein the information comprises at least one of the following:
an indication indicating whether each of the multiple beams is in the set of configured beams; or
an indication indicating whether one of the multiple beams that has a best measurement result is in the set of configured beams.

29. A terminal device, comprising a processor configured to cause the terminal device to:
determine a set of predicted beams by model inference with downlink reference signal measurements on a set of configured beams as an input of the model inference; and
transmit information indicating whether a predicted beam in the set of predicted beams is in the set of configured beams.

30. The terminal device of claim 29, the processor being configured to cause the terminal device to:
receive a configuration indicating association between configured beams and groups of non-configured beams.

31. The m terminal device of claim 29, wherein the information comprises at least one of the following:
an identity of a beam in the set of configured beams that is close to the predicted beam;
an indication indicating that the beam is not the predicted beam; or
an indication indicating that whether the beam is not in a group of non-configured beams.

32. The terminal device of claim 29, wherein the set of predicted beams comprises multiple beams, and wherein the information comprises at least one of the following:
an indication indicating whether each of the multiple beams is in the set of configured beams; or
an indication indicating whether one of the multiple beams that has a best measurement result is in the set of configured beams.
